(19) United States
(12) Patent Application Publication
(10) Pub. No.: US 2024/0354757 A1
(43) Pub. Date: Oct. 24, 2024

(54) SYSTEM AND METHOD FOR CLAIM AND/OR PROOF OF OWNERSHIP OF PHYSICAL ITEMS USING BLOCKCHAIN TECHNOLOGY

(71) Applicant: Alex Parsa Pirseyedi, Toronto (CA)

(72) Inventor: Alex Parsa Pirseyedi, Toronto (CA)

(21) Appl. No.: 18/136,929

(22) Filed: Apr. 20, 2023

(51) Int. Cl. G06Q 20/38

(52) U.S. Cl. CPC G06Q 20/389; G06Q 2220/00

(57) ABSTRACT

A computer-implemented system and method for providing a claim and/or proof of ownership of physical items using blockchain is disclosed. The system inputs a QR code or first unique identification code (UID1) given in a physical item. The system further inputs a QR code or second unique identification code (UID2) from a receipt given to the user at a point-of-sale or transfer. The system creates a unique claim of ownership on a blockchain using the UID1 and UID2 and ties to a UID3 of the user device, thereby providing the claim and/or proof of ownership of physical items. The system keeps track of and manages all assets on the user device with a connection to a main blockchain, thereby allowing a seamless and simplified user-friendly way to bring the claim and/or proof of ownership of physical items to mass market without requiring users to have much technical knowledge or background.

### BACKGROUND OF THE INVENTION

### A. Technical Field

The present invention generally relates to the field of claim and/or proof of ownership of physical objects. More specifically, the present invention relates to a system and method for providing claim and/or proof of ownership of physical items using blockchain technology.

### B. Description of Related Art

Counterfeit and stolen goods are significant problems of global commerce. This results in tremendous losses to product owners without even taking into consideration the deceptive loss for consumers. Further, the resale of stolen goods results in losses for consumers and insurance companies. The problem lies in the inability to truly track real from fake and proper provenance or ownership history.

Blockchain is a distributed digital ledger that stores data of any kind. The blockchain can record information about cryptocurrency transactions, NFT ownership, or Defi smart contracts. The data stored in the blockchain cannot be altered or counterfeited. This enables the blockchain to be used in the field of managing and tracking ownership of physical objects. The global supply chain of the modern commercial enables goods/objects to be manufactured anywhere in the world and then transported to a distant market for sale. Once the ownership of a physical object is listed on the blockchain, ownership is immutable unless the owner verifies a change.

There exist various systems and methods have been developed to control or reduce counterfeit ownership. However, the existing systems and methods are limited to provide physical ownership of various physical items. In addition, the existing systems and methods are useful to some extent for some purposes, these prior efforts sometimes yield a poor experience to users and do not offer seamless and additional beneficial functionality based on verifiable ownership claims and/or proofs.

Therefore, there is a need for a computer-implemented system and method for providing a claim and/or proof of ownership of physical items using blockchain technology. Also, there is a need for a system that provides a seamless and simplified user-friendly and minimalistic way to bring a claim and/or proof of ownership of physical items without requiring users to have much technical knowledge or background.

### SUMMARY OF THE INVENTION

The present invention generally discloses a computer-implemented system and method for providing claim and/or proof of ownership of physical items using blockchain technology. Also, the present invention discloses a system and method for providing a claim and/or proof of ownership of physical items through a simplified registration and management portal. Further, there is a need for a system and method configured to provide a seamless and simplified user-friendly and minimalistic way to bring the claim and/or proof of ownership of physical items.

According to the present invention, the system is executed in a network environment for providing the claim and/or proof of ownership. In one embodiment, the system is an intelligent solution that connects the physical world to the digital world for the claim and/or proof of ownership. In one embodiment, the system is a simplified registration and management portal for providing the claim and/or proof of ownership of physical items. In one embodiment, the system utilizes blockchain technology to create a unique claim of ownership. In one embodiment, the system has a setup, a user interface (UI), and one or more features to allow a seamless and simplified user-friendly and minimalistic way to bring the claim and/or proof of ownership of physical items to the mass market without requiring users to have much technical knowledge or background. In one embodiment, the system is an application software or web-based application or mobile application or desktop application.

In one embodiment, the network environment comprises one or more user devices and a blockchain-based management system. Each user device is associated with a user. In one embodiment, the user device is configured to communicate with the computing device via a communication network using the application software executed in the computer-implemented environment or network environment. In one embodiment, the user device enables the user to access one or more services provided by the system. In one embodiment, the user device communicates with the management system via the network. In one embodiment, the user device is at least any one of a smartphone, a mobile phone, a tablet, a laptop, a desktop, and/or other suitable hand-held electronic communication devices. In an embodiment, the network could be Wi-Fi, WiMAX, wireless local area network (WLAN), satellite networks, cellular networks, private networks, and the like.

In one embodiment, the management system comprises a server or computing device and one or more databases in communication with the computing device. In one embodiment, the computing device may be a cloud server. In one embodiment, the computing device may be operated as a single computer. In some embodiments, the computer may be a touchscreen and/or non-touchscreen and adopted to run on any type of OS, such as iOS™, Windows™, Android™, Unix™, Linux™, and/or others. In one embodiment, the plurality of computers is in communication with each other, via the network. Such communication is established via any one of an application software, a mobile application, a browser, an OS, and/or any combination thereof.

In one embodiment, the database is in communication with the computing device via the network. In one embodiment, the database is accessible by the computing device. In another embodiment, the database is integrated into the computing device or separate from it. In some embodiments, the database resides in a connected server or a cloud computing service. Regardless of location, the database comprises a memory to store and organize certain data for use by the computing device.

In one embodiment, the computing device comprises a computer-readable medium or memory unit and one or more processors coupled to the computer-readable medium. The memory unit stores a set of instructions executable by the processor configured to process claim and/or proof of ownership of various physical items. The memory unit may be a computer readable storage media and/or non-transitory computer readable media. The memory unit may be RAM, ROM (including EPROM, EEPROM, PROM). In one embodiment, the user devices are configured to access the services provided by the computing device via the network.

In one embodiment, the system connects the physical world to the digital world for claim and/or proof of ownership or claim and/or proof of ownership of any physical item or product through the blockchain-based management system. Each physical item is provided with a QR code or first unique identification number (UID1) during or after their manufacturing. In one embodiment, the UID1 carries a unique QR or similar code representing the item's serial number. During purchase, a receipt for the purchase of the physical item contains a QR code or second unique identification number (UID2) at the point-of-sale or transfer. In one embodiment, the receipt may be a paper or digital receipt or similar containing a unique QR or similar code for the physical or digital transaction, which is given to the user at the point-of-sale or transfer. These QR or similar codes may be scanned via an image capturing unit of the user device using a dedicated application software or otherwise input in a similar way. In one embodiment, the user device has a unique serial number and other identification information. In one embodiment, the unique serial number and other identification information of the user device is a third unique identification number (UID3).

In one embodiment, the user device is installed with the dedicated application software. The application software may be a mobile application or web-based application or desktop application. The application software has a user-friendly and minimalistic user interface (UI). In one embodiment, the application software represents a unique digital-wallet. The digital-wallet functions similar to other industry-standard blockchain-based software or hardware wallets. In one embodiment, the digital-wallet may function with a unique 12-word code phrase to allow recovery or loss/change of digital-wallet or any current industry-standard method for recovery of similar wallets.

In one embodiment, the computing device is configured to perform one or more functions using the application software to process minting or claim of ownership and/or proof of ownership for physical items. The computing device is configured to allow the user to scan or otherwise input the UID1 of the physical item and UID2 of the receipt given to the user at the point-of-sale or transfer. The user may be a purchaser/customer/consumer. In one embodiment, the application software creates a unique claim of ownership on the blockchain using the given pair of UIDs and ties them to the user's phone wallet (UID3) within the application software.

In one embodiment, the system may include the registration of the user device, which holds the digital-wallet when it is first purchased itself on the blockchain. In such case, the UID1 that represents the identification of the physical item in the system would be the same as a new device's UID as a special case. The system treats the new device itself as a registration/minted physical item/asset at an initial digital-wallet setup or reactivation. If the user device with the digital-wallet is lost or stolen, a feature on a related web application allows the owner to disable/deactivate the digital-wallet using their private phrase or key. The deactivation is recorded on the blockchain. The blockchain locks all activities until the rightful owner register a new device and use their private pass-phrase to re-activate their digital-wallet on the new device.

In one embodiment, a method uses a computer-implemented system for providing the claim and/or proof of ownership. In one embodiment, the system provides an improved method for processing the claim and/or proof of ownership for physical items, thereby allowing a seamless and simplified user-friendly and minimalistic way to bring the claim and/or proof of ownership of physical items without requiring users to have much technical knowledge or background.

In one embodiment, the method comprises the following steps for processing the claim of ownership. At one step, the computing device allows the user to scan or otherwise input the QR code or first unique identification number (UID1) given in the product or physical item. At another step, the computing device is further configured to scan or otherwise input the QR code or second unique identification number (UID2) from the receipt given to the user at the point-of-sale or transfer. At another step, the application software creates a unique claim of ownership on the blockchain. In one embodiment, the application software creates the unique claim of ownership on the blockchain using the given pair of UIDs and ties them to the user's phone wallet (UID3) all within the same application software. In one embodiment, the application software mints or registers claim of ownership on blockchain automatically using the phone's unique serial number as a third identifier (UID3). At another step, the application software keeps track of and manages all assets on the user device with connection to the main blockchain.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a computer-implemented system executed in a network environment for providing a claim and/or proof of ownership of physical items using blockchain technology in an embodiment of the present invention.

FIG. 2 shows a block diagram illustrating a process minting or claim of ownership in one embodiment of the present invention.

FIG. 3 shows a flowchart of a method for providing the claim and/or proof of ownership of physical items in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

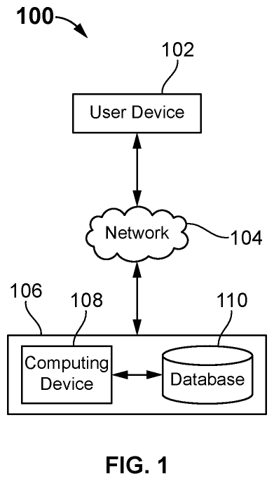

Referring to FIG. 1, a computer-implemented system executed in a network environment 100 for providing a claim and/or proof of ownership of physical items, according to one embodiment of the present invention. In one embodiment, the system is an intelligent solution that connects the physical world to the digital world for the claim and/or proof of ownership. In one embodiment, the system is a simplified registration and management portal for providing the claim and/or proof of ownership of physical items. In one embodiment, the system utilizes blockchain technology to create a unique claim of ownership. In one embodiment, the system has a setup, a user interface (UI), and one or more features to allow a seamless and simplified user-friendly and minimalistic way to bring the claim and/or proof of ownership of physical items to the mass market without requiring users to have much technical knowledge or background. In one embodiment, the system is an application software or web-based application or mobile application or desktop application.

In one embodiment, the network environment 100 comprises one or more user devices 102 and a blockchain-based management system 106. Each user device 102 is associated with a user. In one embodiment, the user device 102 is configured to communicate with the computing device 108 via a communication network 104 using the application software executed in the computer-implemented environment or network environment 100. In one embodiment, the user device 102 enables the user to access one or more services provided by the system. In one embodiment, the user device 102 communicates with the management system 106 via the network 104. In one embodiment, the user device 102 is enabled to access the management system 106 via the network 104. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the management system 106. In an embodiment, the network 104 could be Wi-Fi, WiMAX, wireless local area network (WLAN), satellite networks, cellular networks, private networks, and the like.

In one embodiment, the management system 106 comprises a server or computing device 108 and one or more databases 110 in communication with the computing device 108. In one embodiment, the computing device 108 may be a cloud server. In one embodiment, the computing device 108 may be operated as a single computer. In some embodiments, the computer may be a touchscreen and/or non-touchscreen and adopted to run on any type of OS, such as iOS™, Windows™, Android™, Unix™, Linux™, and/or others. In one embodiment, the plurality of computers is in communication with each other, via the network 104. Such communication is established via any one of an application software, a mobile application, a browser, an OS, and/or any combination thereof.

In one embodiment, the database 110 is in communication with the computing device 108 via the network 104. In one embodiment, the database 110 is accessible by the computing device 108. In another embodiment, the database 110 is integrated into the computing device 108 or separate from it. In some embodiments, the database 110 resides in a connected server or a cloud computing service. Regardless of location, the database 110 comprises a memory to store and organize certain data for use by the computing device 108.

In one embodiment, the computing device 108 comprises a computer-readable medium or memory unit and one or more processors coupled to the computer-readable medium. The memory unit stores a set of instructions executable by the processor configured to process claim and/or proof of ownership of various physical items. The memory unit may be a computer readable storage media and/or non-transitory computer readable media. The memory unit may be RAM, ROM (including EPROM, EEPROM, PROM). In one embodiment, the user devices 102 are configured to access the services provided by the computing device 108 via the network 104. In one embodiment, the computing device 108 is configured to process the claim and/or proof of ownership of physical items.

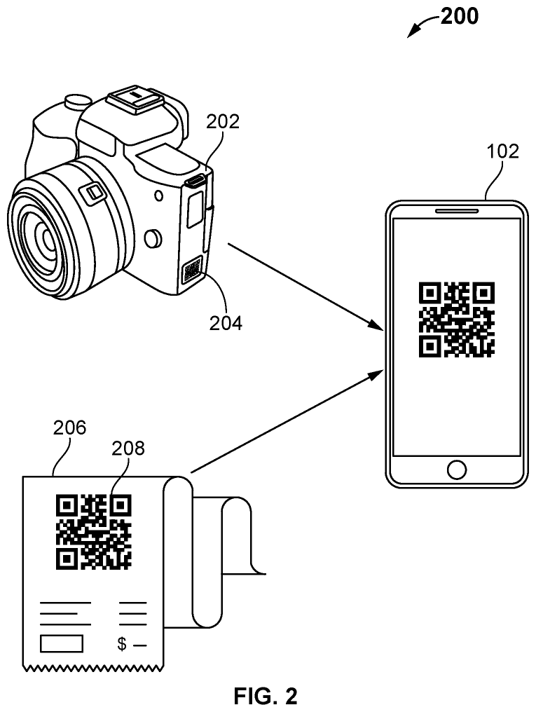

Referring to FIG. 2, a block diagram 200 of a system illustrating a process minting or claim of ownership, according to one embodiment of the present invention. The system connects the physical world to the digital world for claim and/or proof of ownership or claim and/or proof of ownership of any physical item or product 202 through the blockchain-based management system 106. Each physical item 202 is provided with a QR code or first unique identification number (UID1) 204 during or after their manufacturing. In one embodiment, the UID1 204 carries a unique QR or similar code representing the item's serial number. During purchase, a receipt 206 for the purchase of the physical item 202 contains a QR code or second unique identification number (UID2) 208 at the point-of-sale or transfer. In one embodiment, the receipt 206 may be a paper or digital receipt or similar containing a unique QR or similar for the physical or digital transaction, which is given to the user at the point-of-sale or transfer. These QR or similar codes (204 and 208) may be scanned via an image capturing unit of the user device 102 or otherwise input to the user device 102 using a dedicated application software. In one embodiment, the user device 102 has a unique serial number and/or other identification information. In one embodiment, the unique serial number and other identification information of the user device 102 is a third unique identification number (UID3).

In one embodiment, the user device 102 is installed with the dedicated application software. The application software may be a mobile application or web-based application or desktop application. The application software has a minimalistic user interface (UI). In one embodiment, the application software represents a unique digital-wallet. The digital-wallet functions similar to other industry-standard blockchain-based software or hardware wallets. In one embodiment, the digital-wallet may function with a unique 12-word code phrase to allow recovery or loss/change of digital-wallet. In one embodiment, the business model is a subscription or purchase model for manufacturers, producers, distributors, or retailers, similar to subscription or purchase models used for ubiquitous industry-standard universal product code (UPC) subscriptions. Further, the registration and full subscription and/or purchase management are built as part of the overall system.

In one embodiment, the computing device 108 is configured to perform one or more functions using the application software to process minting or claim of ownership and/or proof of ownership for physical items. The computing device 108 is configured to allow the user to scan or otherwise input the UID1 204 of the physical item 202 and UID2 208 of the receipt or similar 206 given to the user at the point-of-sale or transfer. The user may be a purchaser/customer/consumer. In one embodiment, the application software creates a unique claim of ownership on the blockchain using the given pair of UIDs (204 and 208) and ties them to the user's phone wallet (UID3) within the application software.

In one embodiment, the system may include the registration of the user device 102, which holds the digital-wallet when it is first purchased itself on the blockchain. In such case, the UID1 204 that represents the identification of the physical item in the system would be the same as a new device's UID as a special case. The system treats the new device itself as a registration/minted physical item/asset at an initial digital-wallet setup or reactivation. If the user device 102 with the digital-wallet is lost or stolen, a feature on a related web application, for example, on the website, allows the owner to disable/deactivate the digital-wallet using their private phrase or key. The deactivation is recorded on the blockchain. The blockchain locks all activities until the rightful owner register the new device and use their private pass-phrase to re-activate their digital-wallet on the new device.

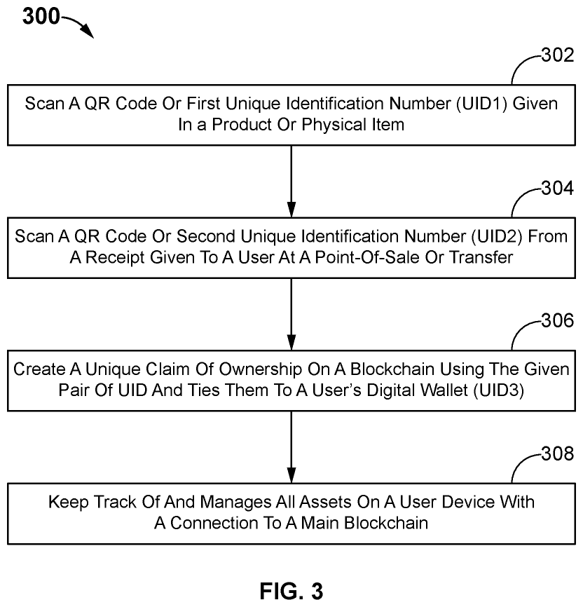

Referring to FIG. 3, a flowchart of a method 300 for processing the claim of ownership of a physical item, according to one embodiment of the present invention. In one embodiment, the method uses a computer-implemented system for providing the claim of ownership. The system comprises a computing device having a non-transitory memory and one or more processors coupled to the non-transitory memory configured to read one or more instructions from the non-transitory memory to process claim of ownership. The system further comprises one or more databases in communication with the computing device via a network configured to store a plurality of claim and/or proof of ownership of various physical items. The system further comprises a user device with a user interface (UI) associated with a user configured to access the computing device via a network. In one embodiment, the system provides an improved method for processing the claim and/or proof of ownership for physical items, thereby allowing a seamless and simplified user-friendly and minimalistic way to bring the claim and/or proof of ownership of physical items without requiring users to have much technical knowledge or background.

In one embodiment, the method comprises the following steps for processing the claim of ownership. At step 302, the computing device allows the user to scan or otherwise input the QR code or first unique identification number (UID1) 204 given in the product or physical item 202. At step 304, the computing device is further configured to scan or otherwise input the QR code or second unique identification number (UID2) 208 from the receipt 206 given to the user at the point-of-sale or transfer. At step 306, the application software creates a unique claim of ownership on the blockchain. In one embodiment, the application software creates the unique claim of ownership on the blockchain using the given pair of UIDs (204 and 208) and ties them to the user's phone wallet (UID3) all within the same application software. In one embodiment, the application software mints or registers claim of ownership on blockchain automatically using the phone's unique serial number as a third identifier (UID3). At step 308, the application software keeps track of and manages all assets on the user device with a connection to a main blockchain.

Advantageously, the system and method of the present invention provide an effective solution for minting or claim of ownership and/or proof of ownership of physical items. The system brings the claim and/or proof of ownership of physical items to the mass market without requiring users to have much technical knowledge or background. The system can have the ability for theft reporting and asset recovery. The system can provide sale and transfer of ownership. The system can provide lost and found functionality. The system can also provide asset tracking and management.

Preferred embodiments of this invention are described herein, including the best mode known to the inventor for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1. A computer-implemented system executed in a network environment for providing claim and/or proof of ownership of physical items using blockchain, comprising:
a computing device having a non-transitory memory and one or more processors coupled to the non-transitory memory configured to read one or more instructions from the non-transitory memory to process the claim and/or proof of ownership;
one or more databases in communication with the computing device via a network configured to store a plurality of ownership details, and
a user device with a user interface (UI) associated with a user configured to access the computing device via a network, wherein the computing device is configured to,
scan or otherwise input a QR code or first unique identification code (UID1) given in or on physical item;
scan or otherwise input a QR code or second unique identification code (UID2) from a receipt or similar given to a user/customer at a point-of-sale or transfer, and
create a unique claim of ownership on a blockchain using the UID1 and UID2 and tie to the user device, thereby providing claim and/or proof of the ownership of the physical item to the user/customer.

2. The system of claim 1, wherein the QR code or second unique identification code (UID2) can be shared among more than one physical items in a group, still allowing for the generation of a unique identifier within the system when combined with the QR code or first unique identification code (UID1) of each individual physical item in the group

3. The system of claim 1, wherein the user device communicates the computing device via the network using an application software or mobile application or web-based application or desktop application executed in a network environment.

4. The system of claim 1, wherein the user device has a unique serial number and other identification information as a third unique identification number (UID3).

5. The system of claim 1, creates the unique claim of ownership on the blockchain using the UID1 and UID2 and ties to the UID3.

6. The system of claim 1, wherein the computing device is further configured to keep track of and manage all assets on the user device with a connection to a main blockchain.

7. The system of claim 1, connects a physical world to a digital world for providing the claim and/or proof of ownership of physical items.

8. The system of claim 1, allows a seamless and simplified user-friendly and minimalistic way to bring the claim and/or proof of ownership of physical items without requiring users to have much technical knowledge or background.

9. The system of claim 1, provides an ability for theft reporting and asset recovery.

10. The system of claim 1, provides sale and transfer of ownership.

11. The system of claim 1, provides lost and found functionality.

12. The system of claim 1, provides asset tracking and management.

13. A method for providing claim and/or proof of ownership using blockchain using a computer-implemented system comprising a computing device having a non-transitory memory and one or more processors coupled to the non-transitory memory configured to read one or more instructions from the non-transitory memory to process a claim and/or proof of ownership, one or more databases in communication with the computing device via a network configured to store a plurality of ownership details, and a user device with a user interface (UI) associated with a user configured to access the computing device via a network, wherein the method comprises the steps of:
scanning or otherwise inputting a QR code or first unique identification code (UID1) given in a physical product;
scanning or otherwise inputting a QR code or second unique identification code (UID2) from a receipt given to a customer at a point-of-sale or transfer;
creating a unique ownership on the blockchain using the UID1 and UID2 and ties to the user device, and
tracking and managing all assets on the user device with a connection to a main blockchain, thereby allowing a seamless and simplified user-friendly and minimalistic way to bring the ownership of physical items to mass market without requiring users to have much technical knowledge or background.
